(19) United States
(12) Patent Application Publication
(10) Pub. No.: US 2005/0194457 A1
(43) Pub. Date: Sep. 8, 2005

(54) Method for programming a thermostat

(75) Inventor: Robert P. Dolan, Syracuse, NY (US)

Correspondence Address: WALL MARJAMA & BILINSKI, 101 SOUTH SALINA STREET, SUITE 400, SYRACUSE, NY, 13202, US

(73) Assignee: Carrier Corporation

(21) Appl. No.: 10/795,478

(22) Filed: Mar. 8, 2004

(51) Int. Cl. F24F 7/00; G05D 23/00

(52) U.S. Cl. 236/51

(57) ABSTRACT

A programmable thermostat is electronically interconnected to a personal computer having an installed program with a graphical user interface for selecting, on a single screen, a schedule of time and temperature pairs for four periods of each day of the week. This schedule can then be easily downloaded into one or more thermostats by the use of a single button. The interconnection between the thermostat and the computer may be made by a USB cable or the like or by way of a wireless interconnection.

### FIELD OF THE INVENTION

This invention relates generally to electronic thermostats and, more particularly, to a method and apparatus for programming a thermostat.

### BACKGROUND OF THE INVENTION

Thermostat controlled systems for heating furnaces and/or air cooling systems of the type employed in residences normally include means for manually entering a desired temperature set point, means for measuring the actual temperature within the building, and means for switching the furnace/air conditioner on and off as a function of the difference between the set point temperature and actual temperature.

The availability of inexpensive integrated circuits incorporating large numbers of digital devices on a similar single semiconductor chip has led to the development of programmable electronic thermostats including means for storing a schedule of desired temperatures at specified times within a respective period such as a day or week. Thus, the users are required to program these thermostats by entering numerous time and temperature pairs so that the thermostat can adjust to their schedules. Most thermostats in this category require four separate time and temperature pairs for each day of the week and a second time and temperature pair for the weekend.

While electronic programmable thermostats enjoy both cost and reliability advantages over conventional mechanical thermostats, they are often limited in their operation and may be difficult or inconvenient for the average homeowner to program and operate. In particular, the limited data entry means and limited display often make it difficult for homeowners unfamiliar with simple computer device programming to successfully program the device or take advantage of all of the features offered by the device.

One approach to facilitate the programming of a programmable thermostat is that shown and described in U.S. Pat. No. 6,628,997 assigned to the assignee of the present invention. That patent which is hereby incorporated herein by reference, describes a process wherein a time-temperature schedule is transformed into a code by a stand-alone external device such as a computer. The programming code is then separately entered into the thermostat where a decoding algorithm is contained. Such a process therefore requires a substantial decoding algorithm to be included in the thermostat and a code with a substantial number of characters to be developed by the computer and entered into the thermostat. The larger the number of characters in the code entered, the smaller the decoding algorithm need be and vice versa.

### SUMMARY OF THE INVENTION

In accordance with one aspect of the invention, a program is installed into a personal computer which is then electronically interconnected to a thermostat to be programmed. Using the installed program, a schedule is established on the computer, and the schedule is then downloaded into the thermostat.

In accordance with another aspect of the invention, a graphical user interface is used for selecting a desired time-temperature schedule to be downloaded to the thermostat.

In accordance with another aspect of the invention, the electrical interconnection between the computer and the thermostat is established by a temporary wired interconnection such as by USB.

In accordance with another aspect of the invention, the electrical interconnection between the computer and the thermostat is established by use of a wireless network.

In the drawings as hereinafter described, a preferred embodiment is depicted; however, various other modifications and alternate constructions can be made thereto without departing from the true spirit and scope of the invention.

### BRIEF DESCRIPTION OF THE DRAWINGS

FIG. 1 is a front view of a programmable thermostat in accordance with the prior art.

FIG. 2 is a flow chart showing the method of programming the programmable thermostat in accordance with the prior art.

FIG. 3 is a flow chart showing a method of programming a thermostat in accordance with a preferred embodiment.

FIG. 4 is another method in accordance with a preferred embodiment of the invention.

FIG. 5 is a block diagram showing the computer/thermostat connection in accordance with a preferred embodiment of the invention.

FIG. 6 is a further block diagram showing particular details of the interconnection.

FIG. 7 is a graphical user interface display in accordance with a preferred embodiment of the invention.

### DESCRIPTION OF THE PREFERRED EMBODIMENT

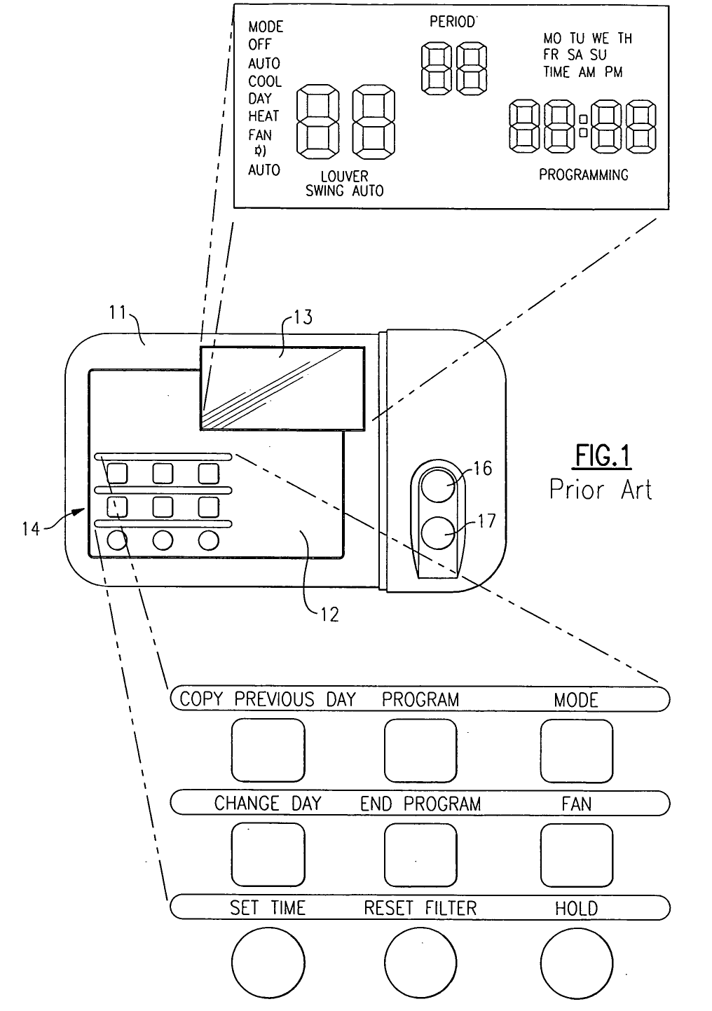

Referring now to FIG. 1, there is shown a programmable thermostat 11 having on its front face 12 an LCD display 13 at the top thereof, a plurality of programming buttons 14 at the lower left, and up and down buttons 16 and 17, respectively at the lower right. The programming buttons 14 allow for a choice of nine functions as indicated, with the LCD display 13 then providing a related read-out as applicable. The up and down buttons 16 and 17 are used to scroll up or down when operating within any one of the functional modes.

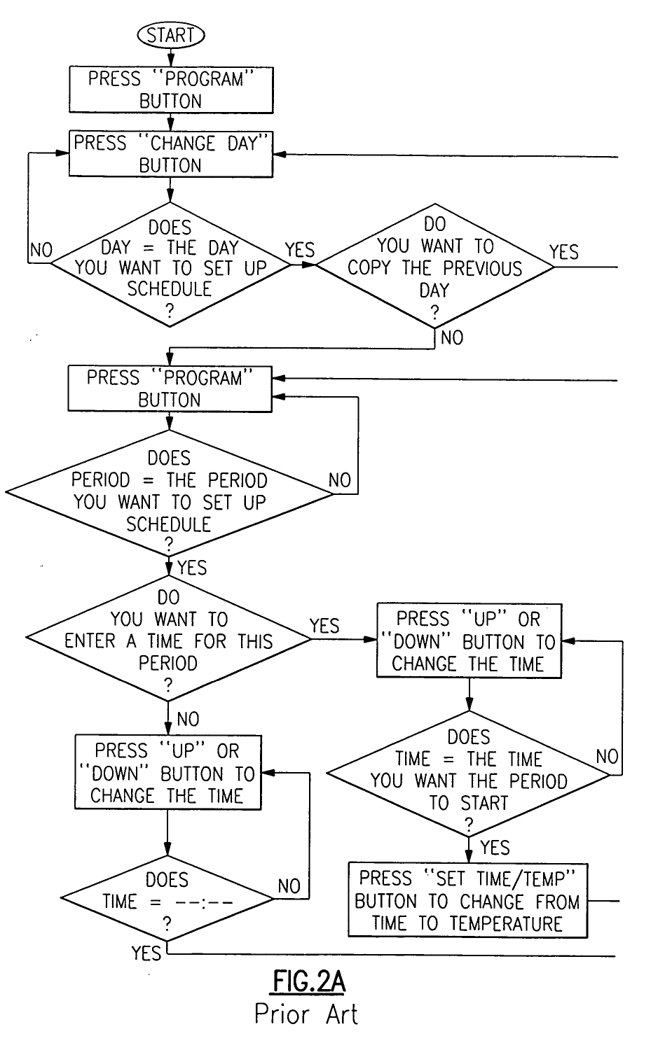

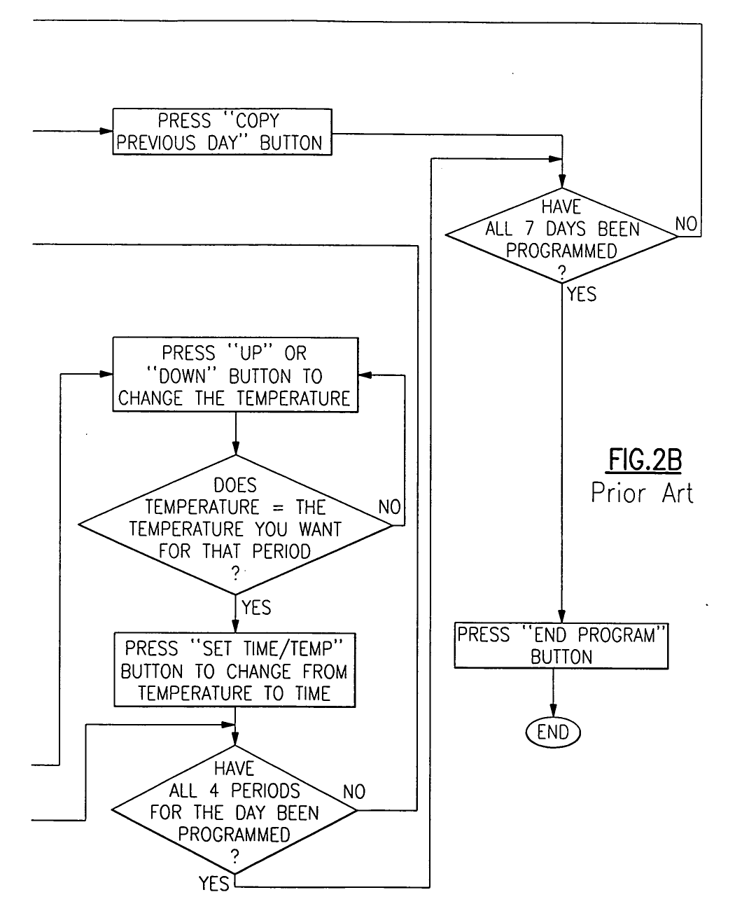

In the programming of such a thermostat, the number of steps required are quite extensive and relatively complicated as shown in FIG. 2. First the “program” button is pressed and then the “change day” button is pressed, after which a choice of one of seven days must be made. Next, the “program” button is pressed until the desired period of time is shown in the LCD display. Then the “up” or “down” buttons is pressed until the desired time is displayed.

After you have set the time to the time that you want the period to start, the “set time” button is pressed to change to the temperature mode. The “up” or “down” buttons are then pressed until the desired temperature is displayed.

Since each day has four periods, it is then necessary to set both the time and temperature values for each of those periods in the manner as described hereinabove.

Also, since there are seven days to program, it is necessary to repeat the complete process as described hereinabove for each of the seven days. It is possible however to use the “copy previous day” if the same settings are desired such as may be the case for the five work days of the week. Saturdays and Sundays will, of course be different from the work days, and, most likely, the Sunday settings will be different from the Saturday settings.

From this discussion it will be seen that the programming of a single thermostat involves a considerable amount of time and effort. In systems where multiple thermostats are involved, such as in zone systems, this procedure must be repeated for each of the individual thermostats.

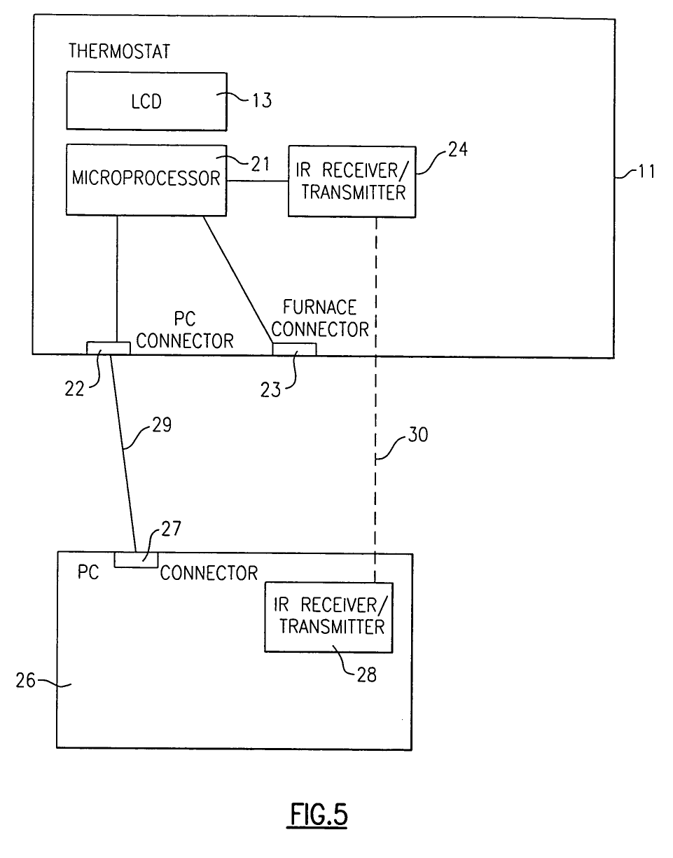

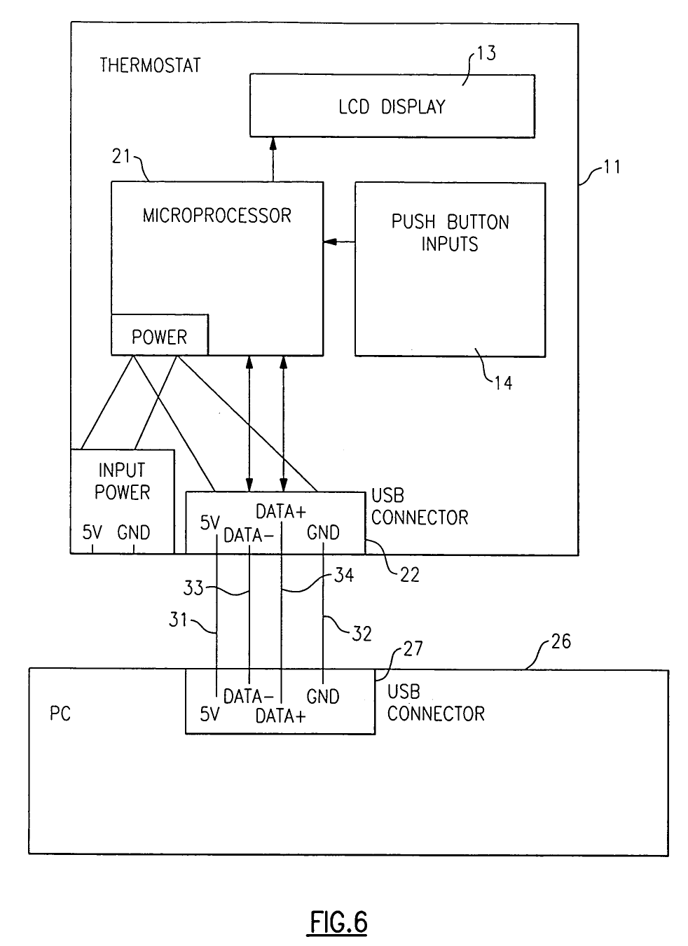

Considering now the present approach, wherein the thermostat is electronically connected to a personal computer, with the thermostat then being programmed by use of the personal computer, there are two ways in which the computer can be connected to the thermostat, one being the temporary hard wiring of one to the other, and the other a wireless connection. These interconnections will be more fully described hereinafter with respect to FIGS. 5 and 6.

It will be seen that the disadvantages of using the normal process for programming a programmable thermostat include the following 1) only one period of four within each date can be viewed at a time. 2) In order to see a schedule for any given day, multiple buttons must be pressed. 3) In order to enter the full schedule, dozen of buttons must be pressed in the proper sequence. 4) Where multiple thermostats are present, each one must be programmed individually.

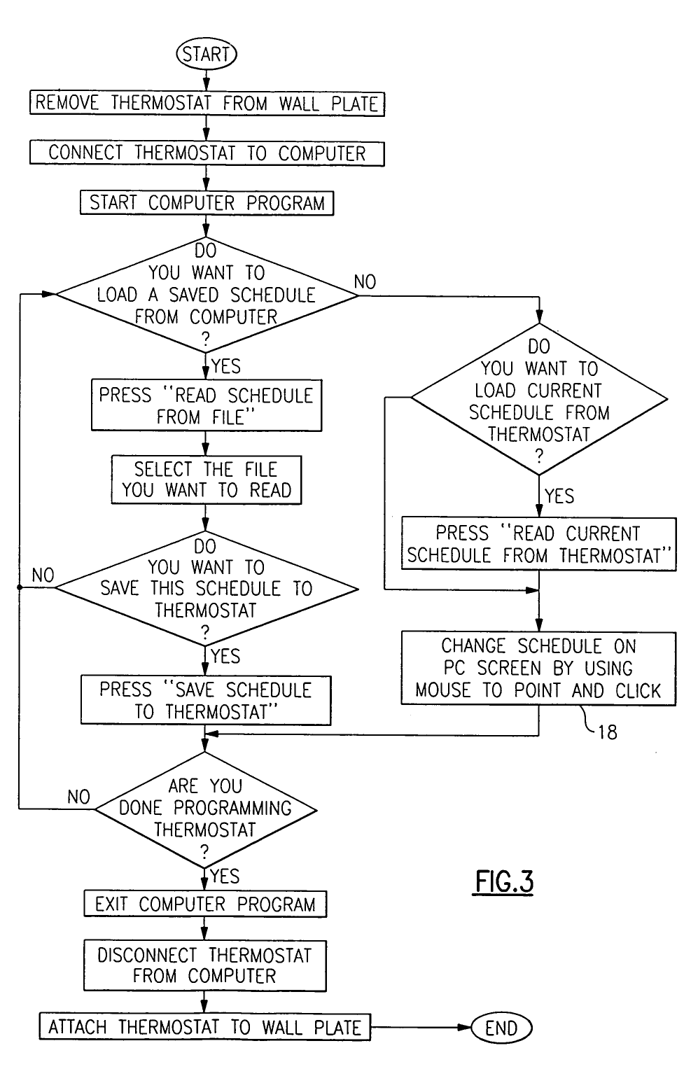

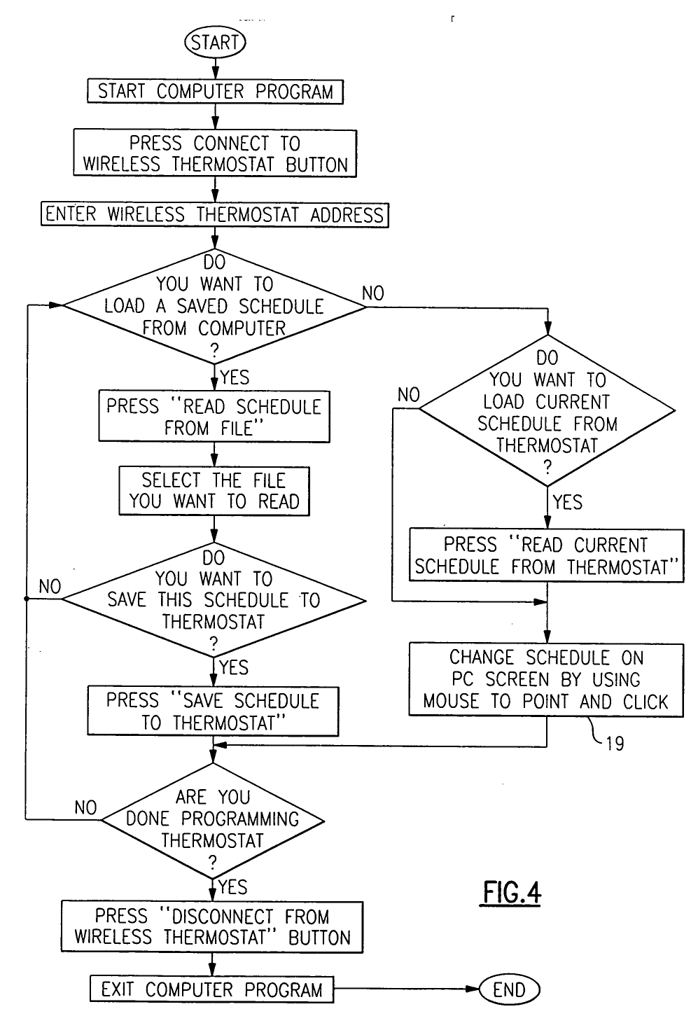

In order for the computer to be used in the process of programming a thermostat, it is necessary to write and install a special program which we shall refer to as a “schedule application program”. One form of such program is shown in FIG. 3 wherein the computer is connected to the thermostat by a temporary hard wiring step. A similar program is shown in FIG. 4 wherein the computer is connected to the thermostat by a wireless interconnection.

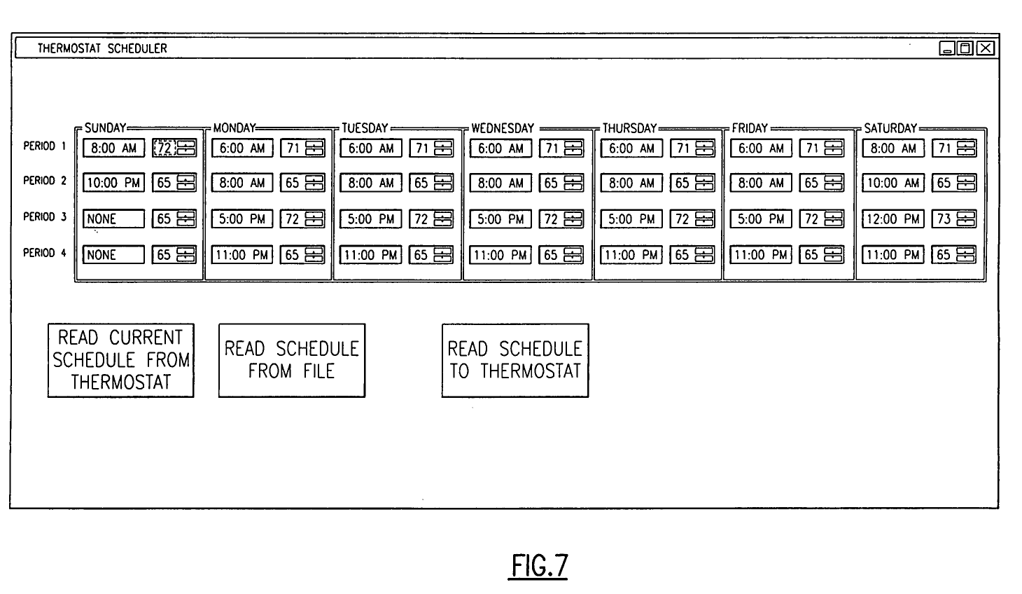

Returning to the flow chart of FIG. 3, after removing the thermostat from the wall plate and connecting the thermostat to the computer by a temporary hard wiring step, the computer program is started. Presuming that this is the first time that the computer is used to program a thermostat, it is necessary to skip to block 18 in the FIG. 3 embodiment or to block 19 in the FIG. 4 embodiment in order to enter the required scheduling data. In this regard, a graphical user interface (GUI), which has been installed as part of the schedule application program, is applied to bring up the image as shown in FIG. 7. Here, it will be seen that a single screen shows each of the four periods for each of the seven days of the week. By simply using the mouse, each of the desired twenty-eight periods can be set in a matter of a couple of minutes. In this way, a complete schedule for the entire week is established and shown on a single image. The schedule application program then allows this data to be saved to the thermostat by the touch of a single button. The operator then exits the schedule application program, disconnects the thermostat from the computer, and, in the case of the hard wired approach as shown in FIG. 3, reattaches the thermostat to the wall plate.

If the computer has previously been used for the programming of thermostats, then it may not be necessary to enter new data into the schedule but rather simply choose the existing schedule and download it to the thermostat. Similarly, if one thermostat has been previously programmed and others are to be programmed with that same schedule, then it can be simply downloaded from the thermostat into the computer and saved for use in programming other thermostats.

The advantages of using the computer for programming functions are as follows: 1) the entire schedule of four periods of each of seven days can be seen at one time. 2) The entire schedule is set in a single screen by using a simple graphical user interface (GUI). 3) Multiple schedules can be saved on the computer so as to be quickly downloaded to a thermostat, a feature that would be very useful for someone that works different shifts. 4) Where multiple thermostats are present, the same schedule can be easily downloaded to each thermostat. 5) Troubleshooting of problems can be more easily accomplished since the service person can see the entire schedule from a single screen.

Considering now the manner in which the computer is electronically connected to the programmable thermostat, there are two possibilities shown in FIG. 5. A thermostat 11 with its LCD display 13, has a microprocessor 21 which is electrically connected to both a PC connector 22 and a Furnace Connector 23, as well as to an IR receiver/transmitter 24. The computer 26 has a PC connector 27 and an IR receiver/transmitter 28.

The electronic interconnection may be by way of a temporary hard wiring between the PC connector 22 of the thermostat to the PC connector 27 of the computer as indicated by the solid line 29 or it may be by way of infra-red transmission between the IR receiver/transmitter 24 of the thermostat 11 and the IR receiver/transmitter 28 of the computer are indicated by dotted line 30. In the case of the temporary hard wired arrangement, the connection 29 may be by any of various possible connections such as serial port, parallel port or USB. In the case of the IR receiver/transmitters 24 and 28, a typical unit that has been found to be useful for this purpose is a 802.11b wireless LAN.

Referring now to FIG. 6, there is shown a typical type of interconnection between the PC connector 22 of the thermostat 11 and the PC connector 27 of the computer 26. A USB cable has two wires 31 and 32 for the conduction of power and two wires 33 and 34 for the conduction of data between the two components. When the thermostat 11 is interconnected by way of the USB cable, it therefore gets its power from the computer, whereas, when it is interconnected by the wireless arrangement 30, the thermostat 11 gets its power from the wall connection. The data flow, on the other hand, travels along lines 33 and 34 in the USB connection and by IR transmission in the case of the wireless arrangement.

It should be understood that the USB (or other connection) may be made by placing the thermostat in a cradle such as with a PDA (Personal Data Assistant).

It will be recognized that the USB cable connection is a temporary connection between the two components only for use in downloading or uploading data between the two. This is contrasted to a permanently hard wired arrangement wherein wires must be run and installed in a house so that the computer may be permanently hard wired to a number of thermostats as in the case of larger industrial installations wherein it is necessary to control and monitor a number of spaces from a central location.

While the present invention has been particularly shown and described with reference to preferred and alternate embodiments as illustrated in the drawings, it will be understood by one skilled in the art that various changes in detail may be effected therein without departing from the true spirit and scope of the invention as defined by the claims.

1. A method of setting a time-temperature schedule in a programmable thermostat, comprising the steps of:
installing a schedule application program into a computer;
electronically interconnecting the computer to the thermostat;
using the schedule application program to select a desired operation schedule of times and associated temperatures; and
downloading said operating schedule to the thermostat.

2. A method as set forth in claim 1 wherein said step of selecting a schedule of times and temperatures is accomplished by way of a graphical user interface (GUI).

3. A method as set forth in claim 1 wherein said step of electronically interconnecting is accomplished by way of temporarily wiring a terminal of the thermostat to a terminal of a computer.

4. A method as set forth in claim 3 wherein said interconnection is by way of a USB cable.

5. A method as set forth in claim 1 where said step of electronically interconnecting is accomplished by way of a wireless network.

6. A method as set forth in claim 1 and including an intermediate step of removing a thermostat from its installed position on a wall prior to said electronic interconnection step.

7. Apparatus for setting a time-temperature schedule in a programmable thermostat, comprising:
a computer;
a program installed in said computer that provides for the selection of a desired time-temperature schedule for operation of a comfort system controlled by the thermostat;
means for electronically interconnecting said computer to the thermostat; and
means for downloading a time-temperature schedule from said computer to the thermostat.

8. Apparatus as set forth in claim 7 wherein said program includes the use of graphical user interface.

9. Apparatus as set forth in claim 7 wherein said program includes means for downloading an existing schedule from said thermostat.

10. Apparatus as set forth in claim 7 wherein said program includes means for storing a schedule.

11. Apparatus as set forth in claim 7 wherein said electronically interconnecting means comprises a USB cable.

12. Apparatus for setting a time-temperature schedule in a plurality of programmable thermostats, comprising:
a computer;
a program installed in said computer that provides for the selection of a desired time-temperature schedule for operation of a comfort system controlled by the thermostats;
means for electronically interconnecting said computer to each of said thermostats separately; and
means for downloading a time-temperature schedule from said computer to each of the thermostats.

13. Apparatus as set forth in claim 12 wherein said program includes the use of graphical user interface.

14. Apparatus as set forth in claim 12 wherein said program includes means for downloading an existing schedule from said thermostats.

15. Apparatus as set forth in claim 12 wherein said program includes means for storing a schedule.

16. Apparatus as set forth in claim 12 wherein said electronically interconnecting means comprises a USB cable.

17. A method as set forth in claim 1 wherein said computer is a personal computer.

18. Apparatus as set forth in claim 7 wherein said computer is a personal computer.

19. Apparatus as set forth in claim 7 wherein said means for electronically interconnecting is accomplished by way of temporarily wiring a terminal of the thermostat to a terminal of a computer.

20. Apparatus as set forth in claim 7 wherein said means for electronically interconnection is accomplished by way of a wireless network.
